(19) United States
(12) Patent Application Publication
(10) Pub. No.: US 2005/0041274 A1
(43) Pub. Date: Feb. 24, 2005

(54) Holographic system and method for retrieving data from the system

(75) Inventor: Tsan-Yuan Chen, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 10/918,482

(22) Filed: Aug. 16, 2004

(30) Foreign Application Priority Data
Aug. 19, 2003 (TW) 92122791

(51) Int. Cl. G03H 1/30; G03H 1/04

(52) U.S. Cl. 359/35

(57) ABSTRACT

A holographic system and a method for retrieving data from the system. When retrieving data from the storage medium of the system, the photo-detector can retrieve correct data along the emitting direction of the signal beam by accurately calculating a reading incident angle of a reference beam and a reading out-going angle of a signal beam, and by adjusting the incident angle of the reference beam.

This application claims the benefit of Taiwan application Serial No. 92122791, filed Aug. 19, 2003, the subject matter of which is incorporated herein by reference.

### BACKGROUND OF THE INVENTION

1. Field of the Invention

The invention relates in general to a holographic system, and particularly to a holographic system and a method for retrieving data from the system.

2. Description of the Related Art

Referring to FIG. 1, a diagram of a conventional holographic system is shown. Generally speaking, the holographic system comprises a signal beam, a data plane, reference beam, a storage material, and a photo-detector.

A light source, a Laser beam for instance, can be split into two light beams by an optical splitter (not shown here), wherein one light beam emits onto a data plane 10, a micromirror array device or a liquid crystal panel, and becomes a signal beam 15, while another light beam is a reference beam 20. When the signal beam 15 and the reference beam 20 emits onto the storage material 30 at the same time, photopolymer for instance, the signal beam 15 and the reference beam 20 will generate an interference fringe 35 formed in the storage material 30. After that, if the storage material 30 is emitted by the reference beam 20 only, a data beam 40 will be outputted along the original extending direction of the signal beam 15 (that is, along the direction of the reading out-going angle of the signal beam), while the data of the data plane 10 can be obtained by placing the photo-detector 50 according to the emitting direction of the data beam 40.

That is to say, when writing into the storage material 30, the interference fringe 35 formed by the emission of the signal beam 15 and reference beam 20 is saved in the storage material 30 to complete the writing of data. When retrieving data, by means of the interference fringe 35 formed on the storage material 30 by the emission of the reference beam 20, the data beam 40 can be outputted along the original extending direction of the signal beam 15, and the data stored in the storage material can be retrieved by the photo-detector 50.

Referring to FIGS. 2(a)˜2(b), the relation among the signal beam, the reference beam, and the interference fringe inside the storage material are shown. In FIG. 2(a), Ks is the direction of the signal beam, Kr is the direction of the reference beam, and K is the direction of the grating (interference fringe), wherein the relation among the three directions is shown in FIG. 2(b), i.e., Kr+K=Ks. Ideally, when retrieving data, the data stored in the storage material can be retrieved when the the photo-detector 50 is perpendicular to the extending direction of the data beam 40.

Deformation would occur to the storage material, photopolymer for instance, due to the writing of data or temperature change, both of which will cause the grating stored in the storage material to change their directions and lengths. Therefore, when retrieving the data stored in the storage material, the photo-detector might not be able to detect the data beam or might detect erroneous data.

### SUMMARY OF THE INVENTION

It is therefore an object of the invention to provide a holographic system and a method accurately calculating the reading incident angle of the reference beam and the position of the photo-detector so as to correctly retrieve data from the system.

The invention achieves the above-identified object by providing a method for retrieving data from a holographic system, wherein the method includes the following steps of: recording the length of the storage material at each direction, the incident angle of the signal beam and that of the reference beam when writing data into the storage material; measuring the deformation amount of the storage material at each direction when retrieving data from the storage material; calculating the reading incident angle of the reference beam and the reading outgoing angle of the signal beam for retrieving data, according to the length of the storage material at each direction, the reading incident angle of the signal beam, the reading incident angle of the reference beam, and the deformation amount of the storage material at each direction that have been recorded; and emitting the reference beam onto the storage material according to the reading incident angle of the reference beam, and placing the photo-detector along the direction of the reading outgoing angle of the signal beam.

The invention achieves the above-identified object by providing a holographic system, including a storage material, a signal beam, a reference beam, a deformation-detecting unit, a calculation unit, and a photo-detector. The signal beam emits onto the storage material at a first incident angle. The reference beam emits the storage material at a second incident angle. The deformation detecting unit detects the deformation amount at each direction of the storage material. The calculation unit calculates the reading incident angle of reference beam and the reading outgoing angle of the signal beam according to the length of the storage material at each direction, the first incident angle, the second incident angle, and the deformation amount of the storage material detected at each direction. The photo-detector is placed along the direction of the reading outgoing angle of the signal beam.

The invention achieves the above-identified object by providing a holographic system, including: a storage material, a deformation-detecting unit, a calculation unit, a reference beam, and a photo-detector. The storage material records an interference fringe, wherein the interference fringe is formed when a first incident beam and a second incident beam emit onto the storage material at a first incident angle and a second incident angle respectively. The deformation detecting unit detects the deformation amount at each direction of the storage material. The calculation unit calculates the reading incident angle of the reference beam and the reading outgoing angle of the signal beam according to the length of the storage material measured at each direction, the first incident angle, the second incident angle, and the deformation amount of the storage material detected at each direction. The reference beam emits onto the storage data according to the reading incident angle of the reference beam. The photo-detector is placed along a direction of the reading outgoing angle of the signal beam.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a diagram of a conventional holographic system.

FIGS. 2(a)˜2(b) show the relation among the signal beam, the reference beam, and the interference fringe inside the storage material.

FIG. 3 shows the relation among the signal beam, reference beam, and the interference fringe after the storage material is deformed.

FIG. 4 shows the relation between the signal beam and the reference beam on the storage material.

FIG. 5 is a flowchart of a method for retrieving data from the holographic system according to a preferred embodiment of the invention.

FIG. 6 is a diagram of a holographic system according to a preferred embodiment of the invention.

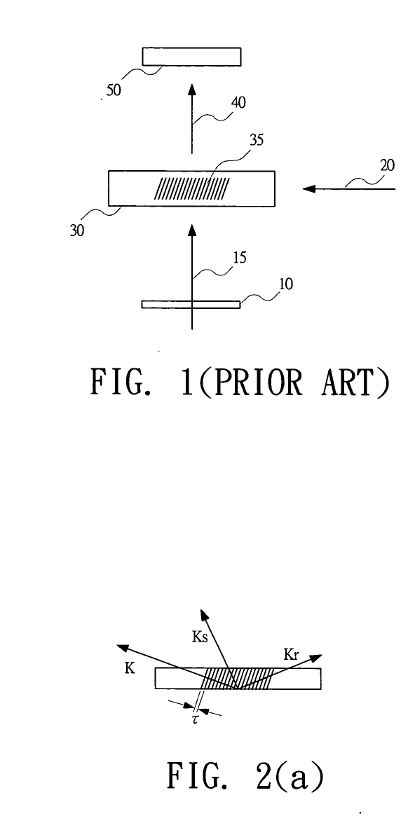

### DETAILED DESCRIPTION OF THE INVENTION

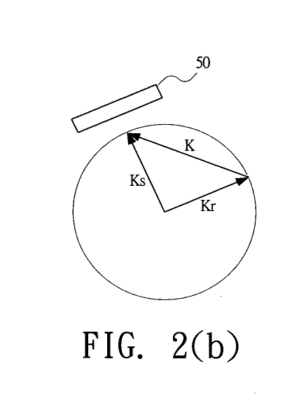

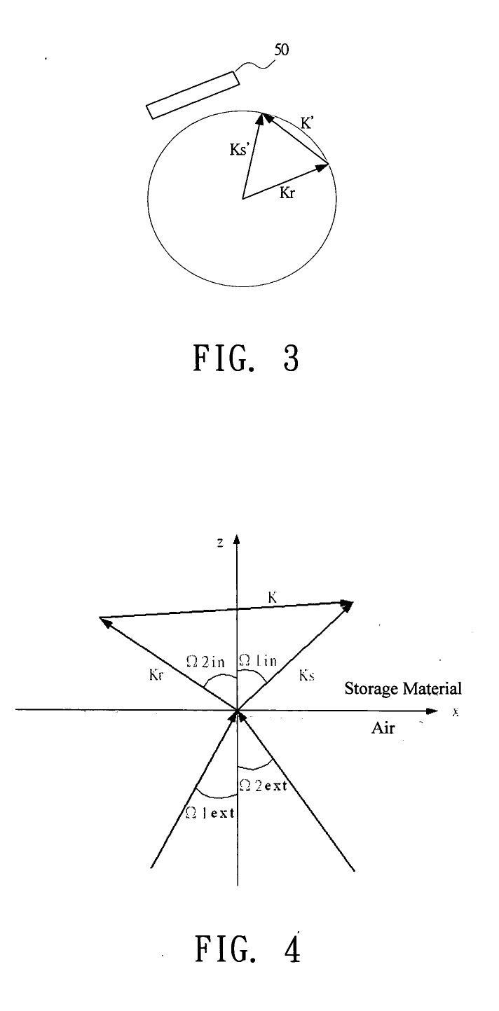

Referring to FIG. 3, the relation among the signal beam, reference beam, and the interference fringe after the storage material is deformed is shown. Compared with FIG. 2(b), when the storage material is deformed, the grating stored in the storage material will change its direction and length, and let K′ be the direction and length changed. Meanwhile, if the reference beam emits onto the storage material without changing the direction, the direction of the outputted data beam Ks' will be different from that of the outputted data beam Ks. Consequently, when retrieving data from the storage material, the photo-detector might not be able to detect the data beam or might detect erroneous data.

Referring to FIG. 4, the relation between the signal beam and the reference beam on the storage material is shown. The incident plane is a plane formed by an X-axis and an Y-axis, Ω1ext is the incident angle of the signal beam in the air, Ω2ext is the incident angle of the reference beam in the air, Ks is the direction of the signal beam in the storage material with the refraction angle of Ks being Ω1in, Kr is the direction of the reference beam in the storage material with the refraction angle of Kr being Ω2in, K is the direction of a grating after an interference fringe is generated by the signal beam and the reference beam.

Further, n is the refractive index of the storage material; Kr+K=Ks; |Ks|=|Kr|=2π/λ, |K|=2π/τ, wherein λ is the wavelength of the signal beam and the reference beam, τ is the special period of the grating.

Therefore, the following formula can be deduced according to the vector addition and the Snell's Law:

$$\begin{matrix}Kz = Ksz - Krz = \frac{2 π}{λ} ( \sqrt{{n}^{2} - {sin}^{2} {Ω}_{1 ext}} - \sqrt{{n}^{2} - {sin}^{2} {Ω}_{2 ext}} ) & ( 1 ) \\ Kx = Ksx - Krx = \frac{2 π}{λ} ( sin {Ω}_{1 ext} + sin {Ω}_{2 ext} ) & ( 2 )\end{matrix}$$

According to (1) and (2), Kz (a component vector of the grating on the Z-axis) and Kx (a component vector of the grating on the X-axis) can be obtained given that the reading incident angle of the reference beam and that of the signal beam are known. Of course, if Kz and Kx are already known, the reading incident angle of the reference beam and that of the signal beam can be obtained accordingly.
Besides, since K=2π/τ, ΔK/K=−Δτ/τ (3)

It can be understood from (3), ΔKi/Ki=−Δτi/τi, wherein i can be X, Y, Z.

That is to say, given τz and Kz, ΔKz can be obtained by measuring the change of Δτz. Similarly, given τx and Kx, ΔKx can be obtained by measuring the change of Δτx.

Since the direction and length of the grating vector when writing data into the storage material are different from that when reading data from the storage material, the length of the storage material at each direction, the incident angle of the reference beam, and the incident angle of the signal beam must be recorded in order to obtain the grating vector K (including the component vector at each direction) and the spacial period τ of the grating (including the component vector at each direction) when writing the data beam into the storage data.

When retrieving the data from the storage material, the deformation amount of the storage material occurring at each direction must be measured again to obtain the change in the spacial period at each direction of the grating, Δτi, wherein i can be X, Y, or Z. Therefore, the change the grating ΔK (including the component vector at each direction) can be obtained according to (3).

Since the grating vector after deformation K′=K+ΔK, the grating vector at each direction after deformation can be obtained as follows:
Kz′=Kz+ΔKz (4)
Kx′=Kx+ΔKx (5)

Applying the results of (4) and (5) into (1) and (2), Ω1ext′ and Ω2ext′, the incident angle of the reference beam and the incident angle of the signal beam can thus be obtained.

The obtained incident angle Ω2ext′ of the reference beam and the obtained incident angle Ω1ext′ of the signal beam mean that the reference beam must emit onto the storage material at an angle of Ω2ext′ when retrieving data from the storage material, and that correct data can be obtained by placing the photo-detector along the emitting direction of Ω1ext′.

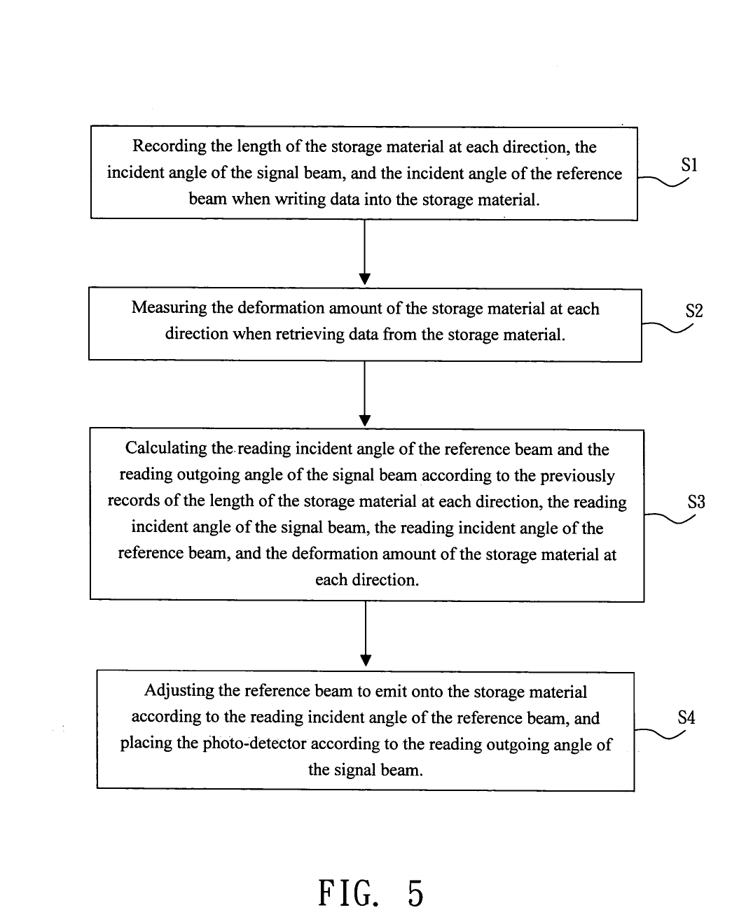

Referring to FIG. 5, a flowchart of a method for retrieving data from the holographic system according to a preferred embodiment of the invention is shown. The method includes the steps of:
Step S1: recording the length of the storage material at each direction, the incident angle of the signal beam, and the incident angle of the reference beam when writing data into the storage material;
Step S2: measuring the deformation amount of the storage material at each direction when retrieving data from the storage material;
Step S3: calculating the reading incident angle of the reference beam and the reading outgoing angle of the signal beam according to the previous records of the length of the storage material at each direction, the incident angle of the signal beam, the incident angle of the reference beam, and the deformation amount of the storage material at each direction; and
Step S4: adjusting the reference beam to emit onto the storage material according to the reading incident angle of the reference beam, and placing the photo-detector according to the reading outgoing angle of the signal beam.

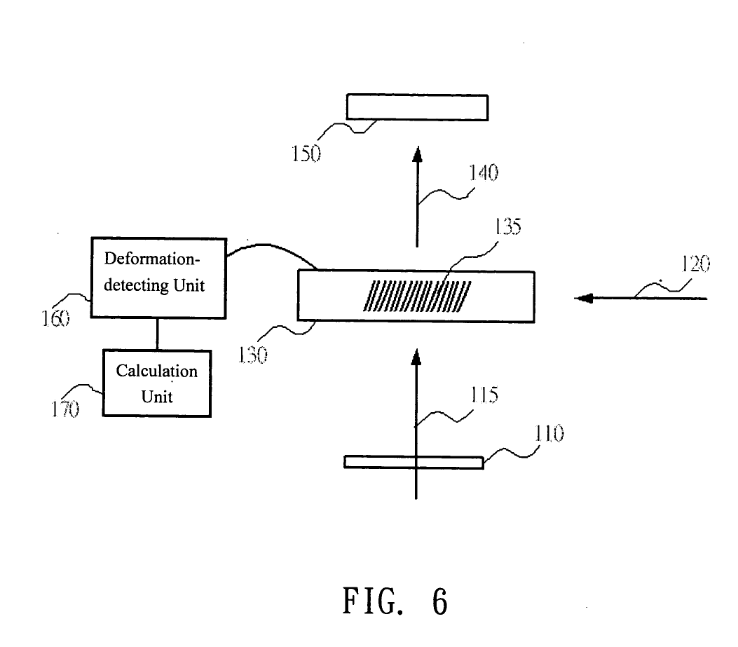

Referring to FIG. 6, a diagram of a holographic system according to a preferred embodiment of the invention is shown. The holographic system includes a signal beam 115, a data plane 110, a reference beam 120, a storage material 130, a deformation-detecting unit 160, a calculation unit 170, and a photo-detector 150.

The deformation detecting unit 160 detects the deformation amount of the storage material 130 at each direction when writing data and when retrieving data. The calculation unit 170 calculates the reading incident angle of the reference beam and the reading outgoing angle of the signal beam according to the length of the storage material 130 at each direction, the incident angle of the signal beam 115, the incident angle of the reference beam 120, and the deformation amount of the storage material 130 at each direction. So, data can be retrieved by providing the reference beam 120 to emit onto the storage material 130 according to the reading incident angle of the reference beam, and can be received by placing the photo-detector 150 along the direction of the reading outgoing angle of the data beam.

To summarize, the invention provides a holographic system and a method for retrieving data from the system. When retrieving data from the storage material, the photo-detector can retrieve correct data along the emitting direction of the signal beam by accurately calculating the reading incident angle of the reference beam and the reading outgoing angle of the signal beam, and by adjusting the incident angle of the reference beam.

While the invention has been described by way of example and in terms of a preferred embodiment, it is to be understood that the invention is not limited thereto. On the contrary, it is the intended to cover various modifications and similar arrangements and procedures, and the scope of the appended claims therefore should be accorded the broadest the interpretation so as to encompass all such modifications and similar arrangements and procedures.

1. A method for retrieving data from a holographic system, comprising the following steps of:
recording lengths of the storage material at a plurality of directions, an incident angle of a signal beam and an incident angle of a reference beam when writing a datum into a storage material;
measuring deformation amounts of the storage material at a plurality of directions when retrieving data from the storage material;
calculating a reading incident angle of the reference beam and a reading outgoing angle of the signal beam according to the lengths of the storage material at the directions, the incident angle of the signal beam, the incident angle of the reference beam, and the deformation amounts of the storage material at the directions; and
emitting a reference beam onto the storage material according to the reading incident angle of the reference beam, and placing a photo-detector along a direction of the reading outgoing angle of the signal beam.

2. The method for retrieving data from a holographic system according to claim 1, wherein the storage material is a photopolymer.

3. The method for retrieving data from a holographic system according to claim 1, a light source forms two light beams via an optical splitter, wherein a first light beam of the two light beams is the reference beam.

4. The method for retrieving data from a holographic system according to claim 3, wherein the light source is a Laser beam.

5. The method for retrieving data from a holographic system according to claim 3, wherein a second light beam of the two light beam forms the signal beam after passing through a data plane.

6. The method for retrieving data from a holographic system according to claim 5, wherein the data plane is a liquid crystal panel.

7. The method for retrieving data from a holographic system according to claim 5, wherein the data plane is a micromirror array device.

8. A holographic system, comprising:
a storage material;
a signal beam, which emits onto the storage material at a first incident angle;
a reference beam, which emits onto the storage material at a second incident angle;
a deformation-detecting unit, which detects a deformation amount of the storage material at each direction;
a calculation unit, the calculation unit which calculates a reading incident angle of the reference beam and a reading outgoing angle of the signal beam according to the length of the storage material at each direction, the first incident angle, the second incident angle, and the deformation amount of the storage material at each direction; and
a photo-detector, placed along a direction of the reading outgoing angle of the signal beam.

9. The holographic system according to claim 8, wherein the storage material is a photopolymer.

10. The holographic system according to claim 8, a light source forms two light beams via an optical splitter, wherein a first light beam of the two light beams is the reference beam.

11. The holographic system according to claim 10, wherein the light source is a Laser beam.

12. The holographic system according to claim 10, wherein a second light beam of the two light beams forms the signal beam after passing through a data plane.

13. The holographic system according to 12, wherein the data plane is a liquid crystal panel.

14. The holographic system according to claim 12, wherein the data plane is a micromirror array device.

15. A holographic system, comprising:
a storage material, which records at least an interference fringe, wherein the interference fringe is formed when a first incident beam and a second incident beam emit onto the storage material at a first incident angle and a second incident angle respectively;
a deformation-detecting unit, which detects a deformation amount of the storage material at each direction;
a calculation unit, which calculates a reading incident angle of the reference beam and a reading outgoing angle of the signal beam according to the length of the storage material at each direction, the first incident angle, the second incident angle, and the deformation amount of the storage material at each direction;
a reference beam, which emits onto the storage data according to the reading incident angle of reference beam; and
a photo-detector, which is placed along a direction of the reading outgoing angle of the signal beam.

16. The holographic system according to 15, wherein the storage material is a photopolymer.
